(19) United States
(12) Patent Application Publication
(10) Pub. No.: US 2011/0069880 A1
(43) Pub. Date: Mar. 24, 2011

(54) THREE-DIMENSIONAL PHOTOGRAPHIC SYSTEM AND A METHOD FOR CREATING AND PUBLISHING 3D DIGITAL IMAGES OF AN OBJECT

(76) Inventor: Dmitry Sergieiev, Vinnitsa (UA)

(21) Appl. No.: 12/993,441

(22) PCT Filed: May 18, 2009
(86) PCT No.: PCT/IB09/52057

§ 371 Date: Nov. 18, 2010

(30) Foreign Application Priority Data
May 23, 2008 (LT) 2008-037

(51) Int. Cl. G06K 9/00; G03B 17/00; H04N 13/02

(52) U.S. Cl. 382/154; 396/428; 348/50; 348/E13.075

(57) ABSTRACT

The present invention provides a three-dimensional photographic system, which is applicable to take pictures of an object from a great variety of angles, particularly for taking series of pictures, which are later combined together forming a three-dimensional digital image of the object (1) and publish it on a server by submitting a link to a client, wherein said system comprises at least an automatic photographic rack, a computer device and a publishing server, said automatic photographic rack preferably comprises two rotating frames (4, 7) having actuators such as stepper motors (3, 5) or the like.

### TECHNICAL FIELD

This invention relates to photographic systems and methods, specifically to the photographic systems and methods for creating rotatable 3D digital images.

### BACKGROUND ART

There are known many inventions related to photographic systems and a lot of methods for taking pictures at different angles to form a three-dimensional digital object as a combination thereof.

In a common way a camera is positioned at different angles using a stand and/or other holding and positioning means like railing, moving frames etc.

German utility model DE202005014072U describes a moving frame assembly having a camera mounting plate, which rotates horizontally about an axis on a carriage running along a rail and moving past the fixed object to be photographed. Rail, carriage and mounting can also be moved along in a direction at right angles to the rail. Comprehensive provisions are made for camera tilt, swing and rise and fall. Adjustments are automated using stepper motors. A computer provides for manual and automatic control of relative positioning, direction and image taking.

The shortcoming of such solution lies in relatively large dimensions of the rail assembly when taking pictures at a constant distance from the object to be photographed. Said system requires at least three actuators, such as stepper motors or hydraulic means thus the control of such-a-system becomes relatively complicated so the cost of the entire system increases. The system is most suitable for taking pictures from a great variety of horizontal angles but not vertical angles.

American patent US2006147188 published on Jul. 6, 2006 describes a photographic shelf, which is highly controllable, adjustable and portable. A loading turntable of the shelf for loading a photographic subject has the functions of horizontal rotation for different angles and vertical angles' switches while cooperating with a hand rod screwing a digital camera.

The shortcoming of this particular invention lies in manual control of the whole assembly. Though the process is not automated it takes very long to shoot hundreds or sometimes even thousands of times and requires a lot of human assistance.

### DISCLOSURE OF INVENTION

### Technical Problem

### Technical Solution

The primary objective of the present invention is to provide a three-dimensional photographic system, which is automatically controlled by a computer using actuators, such as stepper motors or the like. Also a computer system is arranged comprising the controlling computer, main server and client computers wherein controlling computer is arranged to control the photographic system by operating said actuators and to put acquired pictures together forming an integral three-dimensional digital object which could be rotated by means of computer input devices and displayed on a display.

### ADVANTAGEOUS EFFECTS

### Description of Drawings

FIG. 1—photographic system comprising a hanger (11) in a perspective view;

FIG. 2—photographic system comprising a support (9) in a perspective view;

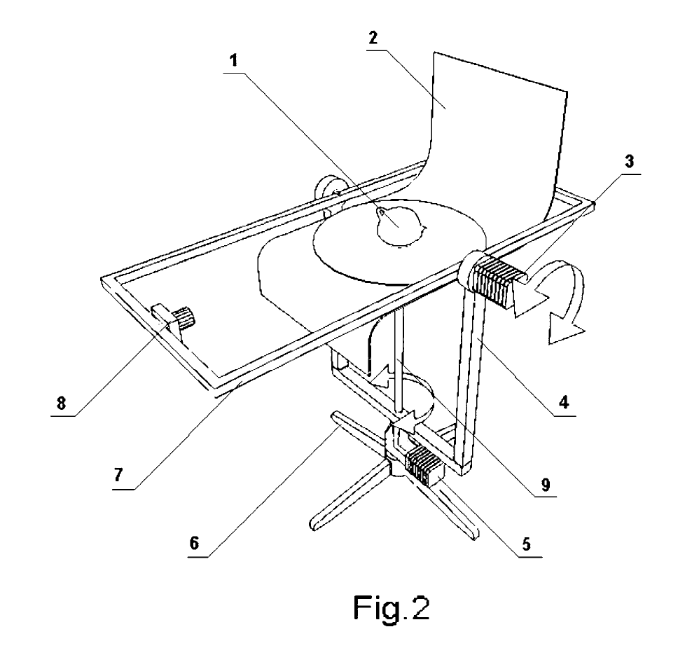

### BEST MODE

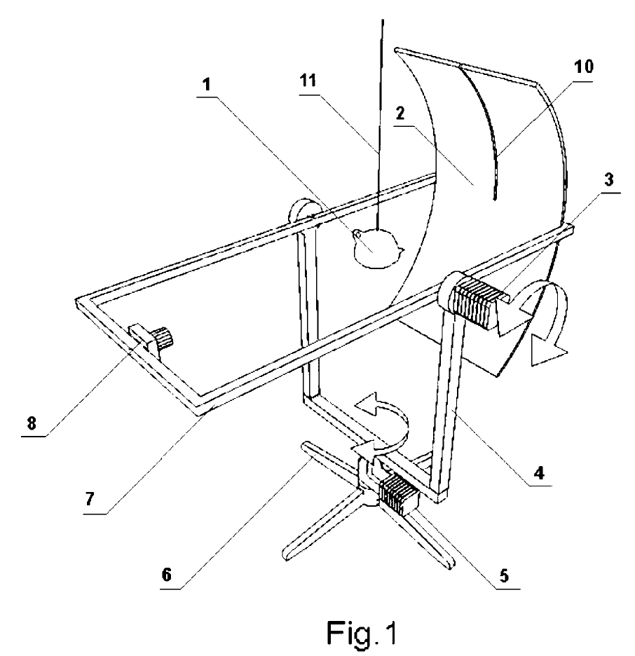

This invention might be implemented by using an electromechanical assembly as shown in FIG. 1. This is the preferred embodiment of the invention though it should not be considered as limiting. To the contrary, it is intended to cover various modifications and similar arrangements and procedures.

According to this invention the electromechanical assembly comprises at least:
a base member (6),
a lower frame member (4), which rotates about an imaginary vertical axis with respect to said base member (6),
an upper frame member (7), which rotates about an imaginary horizontal axis,
a camera (8) arranged at one end of said upper frame member (7),
a backcloth member (2) arranged at the other end of the upper frame member (7), opposite to the said camera (8),
an upper actuator (3) which controls the upper frame member (7) through a gearwheel-type transmission, and
a lower actuator (5) which controls the lower frame member (4) through a gearwheel-type transmission.

The said actuators (3, 5) can be either of a stepper motor type or of a hydraulic type or of a pneumatic type or the like.

The object (1) to be photographed is placed approximately around the imaginary point of intersection of said imaginary axes. Said object (1) to be photographed can be either hanged on a hanger (11) or placed on a support (9), or stand or the like, wherein said support is fixedly arranged with respect to the said base member (6).
Said backcloth member (2) preferably comprises at least one cut (10), which extends from the approximate center of the backcloth member (2) to the lateral side of it. The cut (10) is arranged to receive a shank of the hanger (11) or of the support (9) while rotating the upper frame member (7) in to a vertical position in order to take pictures of the object (1) directly from above or directly from below.

The process of taking pictures preferably consists of the following steps:
placing the object (1) to be photographed on the said support (9) or hanging on the hanger (11),
setting the upper rotating frame member (7) to a starting position wherein the camera (8) is typically either in a position below the object (1) to be photographed or above it,
rotating the upper rotating frame member (7) gradually at a constant speed or rotating and positioning at predetermined angles,
taking pictures at predetermined time intervals when rotating the said upper frame member (7) at a constant speed together with the camera (8), and taking pictures whenever the frame stops in predetermined positions when rotating the said upper frame member (7) at predetermined angles,
rotating the lower frame member (4) at a predetermined angle which usually is not more than 10° and repeating steps 2, 3 and 4,
repeating steps 2, 3, 4, and 5 until the whole object (1) is photographed from all around or pictures of a desired part of the object are taken, e.g. the top and all sides of the object (1) or only the sides etc.

A reverse operation of the whole assembly is also possible. The implication is that the lower frame member (4) rotates at a constant speed or is rotated and positioned at predetermined angles all around and the upper frame member (7) remains oriented at the same horizontal angle. After a set of pictures is taken at the same horizontal angle, changing only the vertical angle of shooting, i.e. rotating only the lower frame member (4), the upper frame member is rotated just a bit in order to change the horizontal shooting angle at a predetermined amount.

Said shooting time intervals or predetermined angles of the rotation of the frames (4, 7) are to be chosen in respect of desired integrity and quality of the final 3D digital image of the object (1). The shorter the predetermined time intervals or the smaller predetermined rotation angles are the better quality and integrity of the final 3D digital image is achieved.

The stepper motors (3, 5) and the camera (8) are controlled by a computer device, which comprises at least a signal output means, program part and data input means, wherein said signal output means are arranged to send controlling signals, preferably in a form of electrical signals or electromagnetic waves, to the controllers of the stepping motors (3, 5) and to a controller of the camera (8) in order to drive said stepping motors (3, 5) in a desired manner and to operate said camera (8) according to a predetermined schedule.

Said program part is arranged to form the said predetermined schedule of camera operation which is strictly coherent to the movement of the upper rotating frame (7) and/or the lower rotating frame (4). The said program part is also suitable for arrangement of the acquired pictures in order to form an integral three-dimensional digital object, which could be rotated by means of computer input devices and displayed on a display. Methods and programs of forming such-a-picture are already in the market.

Said data input means are arranged to receive the picture data from the camera (8). Received picture files are stored in a storing medium and prepared for a further processing.

The controlling signal output means and the data input means can either be as separate connections and interfaces or combined into one standard interface such as USB, FireWire, LAN, Wireless LAN, COM or the like.

The method for creating a three-dimensional digital image further comprises storing of a finished 3D digital object in a server and creating a shortcut to the specific location of the file in the server. Said shortcut is delivered to a customer who can use it in a website, e.g. placing it like a hyperlink. The file containing the said 3D digital object can be also submitted to a customer as a downloadable file or in a physical medium. However the method of creating and providing a shortcut simplifies the whole delivery process and it is more effective and convenient in the customer perspective.

### MODE FOR INVENTION

### INDUSTRIAL APPLICABILITY

Sequence List Text

1. A three-dimensional photographic rack suitable for taking pictures of an object (1) from a great variety of angles, particularly for taking series of pictures, which are later combined together forming a three-dimensional digital image of the object (1), said photographic rack comprising at least one camera (1) and a mechanical assembly, wherein the mechanical assembly comprises at least:
a base member (6),
a lower frame member (4) which rotates about an imaginary vertical axis,
an upper frame member (7), which rotates about an imaginary horizontal axis,
a hanger (11) or a support (9), or a stand or the like, which is used to hold said object (1) to be photographed in a resting position, wherein the object (1) to be photographed is placed on the said support (9) or hanged on the hanger (11) and at least one camera (8) is fixed at one end of the upper frame member (7).

2. A three-dimensional photographic rack according to claim 1, wherein a backcloth member (2) arranged at the other end of the upper rotating frame member (7).

3. A three-dimensional photographic rack according to claim 1, wherein the upper frame member (7) and the lower frame member (4) are interconnected to each other in such way that said imaginary vertical axis of the lower frame member (4) and said imaginary horizontal axis of the upper frame member (7) intersect each other or pass each other at a relatively small distance approximately at one point and at approximately right angles.

4. A three-dimensional photographic rack according to claim 1, wherein said mechanical assembly comprises at least one driving actuator (3, 5), which is arranged to rotate at least one of said frame members (4, 7) in a desired direction.

5. A three-dimensional photographic rack according to claim 4, wherein said driving actuator (3, 5) is of a stepper motor type or of a hydraulic type or of a pneumatic type.

6. A three-dimensional photographic rack according to claim 1, wherein said photographic rack is controlled by a computer device comprising at least:
a signal output means arranged at least to send controlling signals to the controllers of the actuators (3, 5) and the controller of the at least one camera (8),
a program part arranged at least to form a schedule of camera operation which is strictly coherent to the movement of the upper rotating frame (7) and/or the lower rotating frame (4), and
a data input means arranged at least to receive the picture data from the camera (8).

7. A method of creating and publishing 3D digital images of an object comprising the following steps:
taking a series of pictures of an object from different directions using a photographic rack,
combining the pictures acquired into an integral digital 3D image using a computer program product, wherein a photographic rack according claim 1 is used.

8. A method according to claim 7, wherein the electronic publishing of a 3D digital image of the object (1) is embodied by employing the following process steps:
storing of the created file of the digital 3D image of the object in a server
creating a link to the specific location of the said file,
sending of the said link to a customer, who is able to use said link in his website by placing it in a form of hyperlink or the like.

9. A three-dimensional photographic rack according to claim 2, wherein the upper frame member (7) and the lower frame member (4) are interconnected to each other in such way that said imaginary vertical axis of the lower frame member (4) and said imaginary horizontal axis of the upper frame member (7) intersect each other or pass each other at a relatively small distance approximately at one point and at approximately right angles.

10. A three-dimensional photographic rack according to claim 2, wherein said mechanical assembly comprises at least one driving actuator (3, 5), which is arranged to rotate at least one of said frame members (4, 7) in a desired direction.

11. A three-dimensional photographic rack according to claim 3, wherein said mechanical assembly comprises at least one driving actuator (3, 5), which is arranged to rotate at least one of said frame members (4, 7) in a desired direction.

12. A three-dimensional photographic rack according to claim 2, wherein said photographic rack is controlled by a computer device comprising at least:
a signal output means arranged at least to send controlling signals to the controllers of the actuators (3, 5) and the controller of the at least one camera (8),
a program part arranged at least to form a schedule of camera operation which is strictly coherent to the movement of the upper rotating frame (7) and/or the lower rotating frame (4), and
a data input means arranged at least to receive the picture data from the camera (8).

13. A three-dimensional photographic rack according to claim 3, wherein said photographic rack is controlled by a computer device comprising at least:
a signal output means arranged at least to send controlling signals to the controllers of the actuators (3, 5) and the controller of the at least one camera (8),
a program part arranged at least to form a schedule of camera operation which is strictly coherent to the movement of the upper rotating frame (7) and/or the lower rotating frame (4), and
a data input means arranged at least to receive the picture data from the camera (8).

14. A three-dimensional photographic rack according to claim 4, wherein said photographic rack is controlled by a computer device comprising at least:
a signal output means arranged at least to send controlling signals to the controllers of the actuators (3, 5) and the controller of the at least one camera (8),
a program part arranged at least to form a schedule of camera operation which is strictly coherent to the movement of the upper rotating frame (7) and/or the lower rotating frame (4), and
a data input means arranged at least to receive the picture data from the camera (8).

15. A three-dimensional photographic rack according to claim 5, wherein said photographic rack is controlled by a computer device comprising at least:
a signal output means arranged at least to send controlling signals to the controllers of the actuators (3, 5) and the controller of the at least one camera (8),
a program part arranged at least to form a schedule of camera operation which is strictly coherent to the movement of the upper rotating frame (7) and/or the lower rotating frame (4), and
a data input means arranged at least to receive the picture data from the camera (8).

16. A method of creating and publishing 3D digital images of an object comprising the following steps:
taking a series of pictures of an object from different directions using a photographic rack,
combining the pictures acquired into an integral digital 3D image using a computer program product, wherein a photographic rack according claim 2 is used.

17. A method of creating and publishing 3D digital images of an object comprising the following steps:
taking a series of pictures of an object from different directions using a photographic rack,
combining the pictures acquired into an integral digital 3D image using a computer program product, wherein a photographic rack according claim 3 is used.

18. A method of creating and publishing 3D digital images of an object comprising the following steps:
taking a series of pictures of an object from different directions using a photographic rack,
combining the pictures acquired into an integral digital 3D image using a computer program product, wherein a photographic rack according claim 4 is used.

19. A method of creating and publishing 3D digital images of an object comprising the following steps:
taking a series of pictures of an object from different directions using a photographic rack,
combining the pictures acquired into an integral digital 3D image using a computer program product, wherein a photographic rack according claim 5 is used.

20. A method of creating and publishing 3D digital images of an object comprising the following steps:
taking a series of pictures of an object from different directions using a photographic rack,
combining the pictures acquired into an integral digital 3D image using a computer program product, wherein a photographic rack according claim 6 is used.
